(19) United States
(12) Patent Application Publication
(10) Pub. No.: US 2026/0027753 A1
(43) Pub. Date: Jan. 29, 2026

(54) MOLDING DIE, RESIN MOLDING APPARATUS, AND METHOD FOR PRODUCING RESIN MOLDED PRODUCT

(71) Applicant: TOWA CORPORATION, Kyoto (JP)

(72) Inventors: Yusuke YOSHIDA, Kyoto (JP); Yohei ONISHI, Kyoto (JP); Mamoru SUNADA, Kyoto (JP); Ken MORITA, Kyoto (JP); Atsushi MORIKAMI, Kyoto (JP)

(73) Assignee: TOWA CORPORATION, Kyoto (JP)

(21) Appl. No.: 18/995,789

(22) PCT Filed: Aug. 31, 2023
(86) PCT No.: PCT/JP2023/031744

§ 371 Date: Jan. 16, 2025

(30) Foreign Application Priority Data
Dec. 26, 2022 (JP) 2022-207892

(51) Int. Cl. B29C 33/68; B29C 43/36

(52) U.S. Cl. CPC B29C 33/68; B29C 43/36

(57) ABSTRACT

A molding die includes one die and the other die arranged opposing the one die, the other die having a cavity where a release film is arranged. The other die includes a main surface member that forms a main surface of the cavity and a side surface member that forms a side surface of the cavity. On an opposing surface of the side surface member opposing the one die, a release film adsorption hole that adsorbs the release film is formed including a plurality of first suction holes and a second suction hole that connects adjacent first suction holes. On the opposing surface, the first suction hole is larger than the second suction hole in the direction perpendicular to the direction in which the second suction hole extends to connect adjacent first suction holes.

### TECHNICAL FIELD

The disclosure relates to a technology of a molding die, a resin molding apparatus, and a method for producing a resin molded product.

### RELATED ART

Patent Document 1 discloses a molding die provided with a release film to facilitate removing a resin molded product. In the molding die described in Patent Document 1, an adsorption hole and a gap for adsorbing the release film are formed. Specifically, in the molding die described in Patent Document 1, an adsorption hole capable of holding the release film in a suction manner is formed on an outside of a cavity. In the molding die described in Patent Document 1, a gap capable of holding the release film in a suction manner is formed on an inside (between a compression mold and a frame-shaped mold) of the cavity. A vacuum pump is connected to the adsorption hole and the gap of the molding die, and is configured so that suctioning can be respectively and independently performed.

In the molding die configured in this way, first, the release film is adsorbed by the adsorption hole, and the release film is adsorbed and fixed to a surface of the molding die. Then, the release film is adsorbed by the gap, resulting in the release film being adsorbed along the shape of the cavity.

### PRIOR-ART DOCUMENTS

### Patent Documents

Patent Document 1: Japanese Patent Laid-Open No. 2009-298096

### SUMMARY OF INVENTION

### Problems to Be Solved by the Invention

However, in the case where the release film is adsorbed by the adsorption hole on the outside of the cavity and then adsorbed from the gap on the inside of the cavity as described in Patent Document 1, a large stress may be applied to the release film due to adsorption from the gap. When the large stress is applied to the release film, the release film may not be able to be properly held, such as that wrinkles may be formed in the release film or the release film may slip, and there is a possibility of molding defects or release defects occurring in the resin molded product. In this regard, there is room for improvement.

The disclosure has been made in view of circumstances as described above, and a problem to be solved is to provide a molding die, a resin molding apparatus, and a method for producing a resin molded product, which make it possible to prevent molding defects or release defects from occurring in the resin molded product.

### Means for Solving the Problems

A problem to be solved by the disclosure is as described above. To solve this problem, a molding die according to the disclosure includes one die and the other die arranged opposing the one die and having a cavity where a release film is arranged. The other die includes a main surface member forming a main surface of the cavity and a side surface member forming a side surface of the cavity. On an opposing surface of the side surface member that opposes the one die, a release film adsorption hole that adsorbs the release film is formed including multiple first suction holes and a second suction hole connecting adjacent ones of the first suction holes. On the opposing surface, the first suction hole is larger than the second suction hole in terms of a length in a direction perpendicular to a direction in which the second suction hole extends to connect adjacent ones of the first suction holes.

A resin molding apparatus according to the disclosure includes the molding die.

A method for producing a resin molded product according to the disclosure is a method for producing a resin molded product using the resin molding apparatus. The method includes a film arrangement process for arranging the release film on the other die, and a resin molding process for performing resin molding using the other die on which the release film is arranged.

### Effects of Invention

According to the disclosure, molding defects or release defects can be prevented from occurring in the resin molded product.

### BRIEF DESCRIPTION OF THE DRAWINGS

FIG. 1 is a schematic plan view showing an overall configuration of a resin molding apparatus according to a first embodiment.

FIG. 2 is a schematic side view showing a configuration of a molding module.

FIG. 3 is a plan view showing a lower die.

FIG. 4 is a plan cross-sectional view showing the lower die.

FIG. 5 (a) is an enlarged view showing portion A of FIG. 3; (b) is a cross-sectional view along S-S.

FIG. 6 (a) is a cross-sectional view showing a state in which a first adsorption part adsorbs a release film; (b) is a cross-sectional view showing a state in which a second adsorption part adsorbs the release film; (c) is a cross-sectional view showing a state in which a third adsorption part adsorbs the release film.

FIG. 7 (a) is a plan view showing the lower die according to a second embodiment; (b) is an enlarged view showing portion B.

FIG. 8 is a plan view showing the lower die according to a third embodiment.

### DESCRIPTION OF THE EMBODIMENTS

### Overall Configuration of Resin Molding Apparatus 1

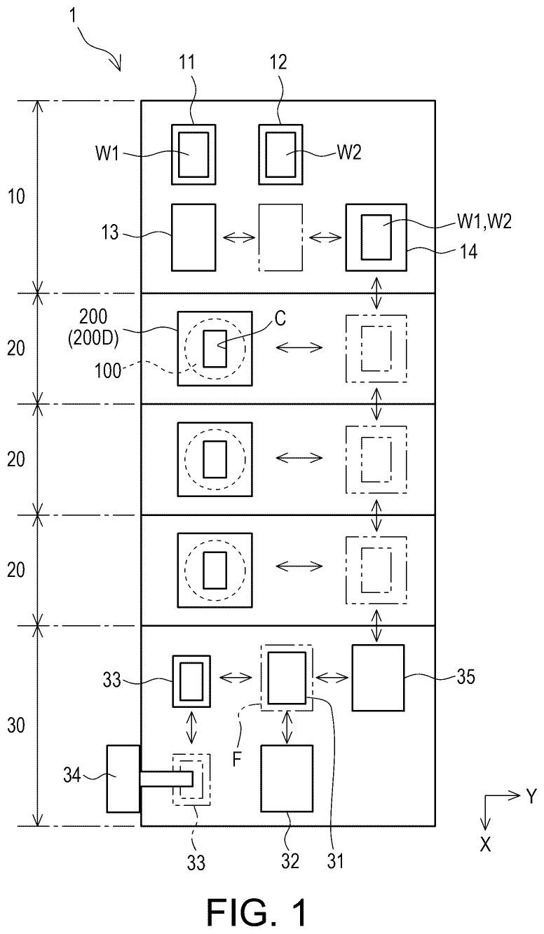

First, a resin molding apparatus 1 according to a first embodiment of the disclosure will be described using FIG. 1. In the description using FIG. 1, directions are defined using arrows X and Y shown in the figure. The resin molding apparatus 1 performs resin sealing on a pre-sealing substrate W1 and produces a resin molded product (sealed substrate W2). In the present embodiment, a substrate before resin sealing is referred to as the pre-sealing substrate W1, and a substrate after resin sealing is referred to as the sealed substrate W2. In the present embodiment, the resin molding apparatus 1 that performs resin molding by a compression molding method is illustrated as an example.

The resin molding apparatus 1 includes, as components, a substrate supply and storage module 10, a molding module 20, and a material supply module 30. Each component is detachable and replaceable with respect to other components.

The substrate supply and storage module 10 supplies the pre-sealing substrate W1 to the molding module 20 and stores the sealed substrate W2 received from the molding module 20. As the pre-sealing substrate W1, various substrates (glass epoxy substrate, ceramic substrate, resin substrate, and metal substrate) including lead frames may be used. The substrate supply and storage module 10 mainly includes a pre-sealing substrate supply part 11, a sealed substrate storage part 12, a substrate placement part 13, and a substrate conveyance mechanism 14.

The substrate placement part 13 appropriately transfers the pre-sealing substrate W1 and the sealed substrate W2 between the pre-sealing substrate supply part 11, the sealed substrate storage part 12, and the substrate conveyance mechanism 14. The substrate placement part 13 is able to move in the Y direction within the substrate supply and storage module 10. The pre-sealing substrate supply part 11 is able to supply the pre-sealing substrate W1 to the substrate placement part 13. The sealed substrate storage part 12 is able to store the sealed substrate W2 received from the substrate placement part 13. The substrate conveyance mechanism 14 is able to move in the X direction and Y direction within the substrate supply and storage module 10 and the molding module 20. The substrate conveyance mechanism 14 is able to appropriately convey the pre-sealing substrate W1 and the sealed substrate W2 across the substrate supply and storage module 10 and the molding module 20.

The molding module 20 performs resin molding. In the present embodiment, the resin molding apparatus 1 provided with three molding modules 20 is illustrated as an example. However, the number of molding modules 20 is not limited. The molding module 20 mainly includes a mold clamping mechanism 100 and a molding die 200.

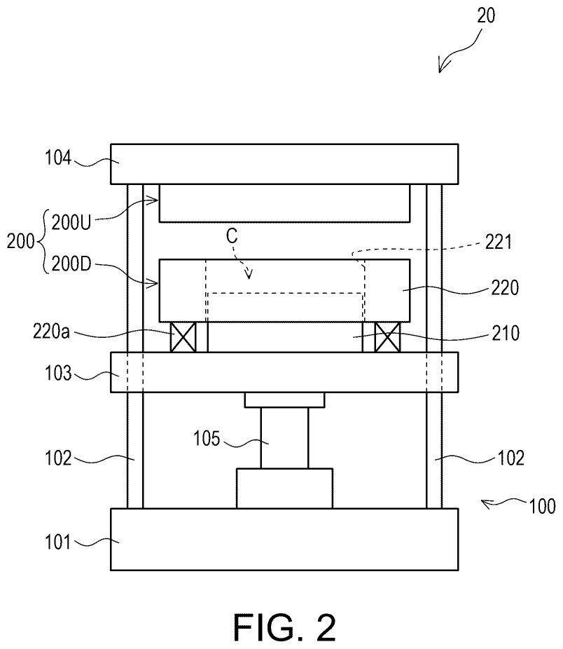

The molding die 200 includes an upper die 200U (see FIG. 2 and so on) and a lower die 200D that can be raised and lowered with respect to the upper die 200U. The upper die 200U and the lower die 200D are respectively one embodiment of one die and the other die of the disclosure. A cavity C corresponding to the shape of the resin molded product is formed in the lower die 200D. The mold clamping mechanism 100 is able to perform mold clamping and mold opening of the molding die 200 by raising and lowering the lower die 200D. A more specific configuration of the molding module 20 will be described later.

The material supply module 30 supplies a release film F and a resin material to the molding module 20. The material supply module 30 mainly includes a material placement part 31, a release film supply mechanism 32, a resin material accommodation part 33, a resin material feeding mechanism 34, and a material conveyance mechanism 35.

The material placement part 31 allows the release film F and the resin material accommodation part 33 to be placed thereon. The material placement part 31 is able to move in the X direction and Y direction within the material supply module 30. The release film supply mechanism 32 is able to supply the release film F to the material placement part 31.

The resin material accommodation part 33 is of a substantially frame-like shape, and can be integrated with the release film F supplied to the material placement part 31 to be able to accommodate the resin material supplied from the resin material feeding mechanism 34. The material conveyance mechanism 35 is able to move in the X direction and Y direction within the material supply module 30 and the molding module 20. The material conveyance mechanism 35 is able to convey, to the molding module 20, the release film F and the resin material accommodation part 33 that are integrated with each other, along with the resin material.

### Resin Molding Method Using Resin Molding Apparatus 1

The following describes an example of a resin molding method using the resin molding apparatus 1 configured as described above.

A method for producing a resin molded product according to the present embodiment mainly includes a substrate carrying-in process, a film arrangement process, a mold clamping process, a resin molding process, a mold opening process, and a carrying-out process. The above will be described in order below.

First, in the substrate carrying-in process, the pre-sealing substrate W1 is carried into the molding die 200. Specifically, in the substrate carrying-in process, the pre-sealing substrate W1 is supplied from the pre-sealing substrate supply part 11 to the substrate placement part 13. The substrate conveyance mechanism 14 receives the pre-sealing substrate W1 placed on the substrate placement part 13 and conveys the pre-sealing substrate W1 to the molding die 200 of the molding module 20.

Next, in the film arrangement process, the release film F and the resin material are arranged in the molding die 200 (lower die 200D). Specifically, in the film arrangement process, the release film F is supplied from the release film supply mechanism 32 to the material placement part 31. At this time, it is also possible to cut the release film F into a predetermined size as appropriate on the material placement part 31. The release film F placed on the material placement part 31 is integrated with the resin material accommodation part 33 placed thereon to form a box-like shape capable of accommodating the resin material. The resin material is fed from the resin material feeding mechanism 34 into the release film F and the resin material accommodation part 33 that are integrated with each other, and the release film F and the resin material accommodation part 33 accommodating the resin material are placed on the material placement part 31. The material conveyance mechanism 35 receives the release film F and the resin material accommodation part 33 accommodating the resin material, moves to the molding module 20, and arranges the release film F and the resin material accommodation part 33 accommodating the resin material in the molding die 200 (lower die 200D). After that, as described later, the release film F is held in the lower die 200D, and the resin material is supplied to the cavity C of the lower die 200D. After the resin material is supplied to the cavity C, the resin material accommodation part 33 is carried out from the molding die 200 by the material conveyance mechanism 35 and returned to the material supply module 30.

Next, in the mold clamping process, the molding die 200 is clamped. Specifically, in the mold clamping process, the resin material accommodated in the cavity C is heated by a heating mechanism (not shown) provided in the lower die 200D. Next, by driving the mold clamping mechanism 100, the lower die 200D is raised toward the upper die 200U. When the lower die 200D is raised to a predetermined position, an upper surface of the lower die 200D and a lower surface of the upper die 200U directly contact each other, or indirectly contact each other via the pre-sealing substrate W1, and the cavity C formed in the lower die 200D is blocked from above by the upper die 200U or the pre-sealing substrate W1. In this state, by further pushing the lower die 200D up, the resin material accommodated in the lower die 200D is pressurized.

Next, in the resin molding process, the resin material is cured and resin molding is performed. Specifically, in the resin molding process, the resin material is kept on standby for a predetermined time while being pressurized. Accordingly, the resin material can be cured, resin molding can be performed on the pre-sealing substrate W1, and a resin molded product (sealed substrate W2) can be obtained.

Next, in the mold opening process, the molding die 200 is opened. Specifically, in the mold opening process, by driving the mold clamping mechanism 100, the lower die 200D is lowered to move away from the upper die 200U. Accordingly, the molding die 200 is opened, and a state is achieved in which the sealed substrate W2 can be removed.

Next, in the carrying-out process, the resin molded product (sealed substrate W2) is carried out from the molding die 200. Specifically, in the carrying-out process, the substrate conveyance mechanism 14 receives the sealed substrate W2 from the molding die 200 and transfers the received sealed substrate W2 to the substrate placement part 13 of the substrate supply and storage module 10. The sealed substrate storage part 12 receives the sealed substrate W2 from the substrate placement part 13 and stores the received sealed substrate W2.

In this way, in the resin molding apparatus 1, the pre-sealing substrate W1, the release film F, and the resin material or the like can be supplied to the molding module 20, and resin molding can be performed. Resin molding can be performed in parallel in multiple molding modules 20, enabling efficient production of resin molded products. The above operations of each part of the resin molding apparatus 1 can be appropriately controlled by a control device (not shown).

### Configuration of Molding Module 20

The following describes a specific configuration of the molding module 20. As shown in FIG. 2, the molding module 20 mainly includes the mold clamping mechanism 100 and the molding die 200 and so on.

The mold clamping mechanism 100 raises and lowers the lower die 200D to perform mold clamping and mold opening and so on. The mold clamping mechanism 100 mainly includes a base 101, a post 102, a lower die base member 103, an upper die base member 104, and a drive mechanism 105 and so on.

The base 101 supports the molding die 200 and so on. Multiple posts 102 are fixed to the base 101. The multiple posts 102 are provided to extend upward from the base 101. The lower die base member 103 is provided at an up-down direction intermediate portion of the post 102 so as to be movable up and down. The upper die base member 104 is fixed to an upper end of the post 102.

The drive mechanism 105 is for raising and lowering the lower die 200D. As the drive mechanism 105, a ball screw mechanism, hydraulic cylinder, toggle mechanism or the like can be used. The drive mechanism 105 is arranged between the base 101 and the lower die base member 103. By extending and contracting in the up-down direction between the base 101 and the lower die base member 103, the drive mechanism 105 is able to raise and lower the lower die base member 103.

The molding die 200 is composed of the upper die 200U and the lower die 200D, and forms the cavity C for molding the resin material.

The upper die 200U is formed to have an appropriate width in the up-down direction. The upper die 200U is arranged with a surface (mold surface) for molding resin facing downward. The mold surface of the upper die 200U is formed as a flat surface without any unevenness. The upper die 200U is fixed to a bottom surface of the upper die base member 104. On the mold surface of the upper die 200U, an adsorption hole (not shown) capable of adsorbing a substrate (pre-sealing substrate W1 and sealed substrate W2) is appropriately formed.

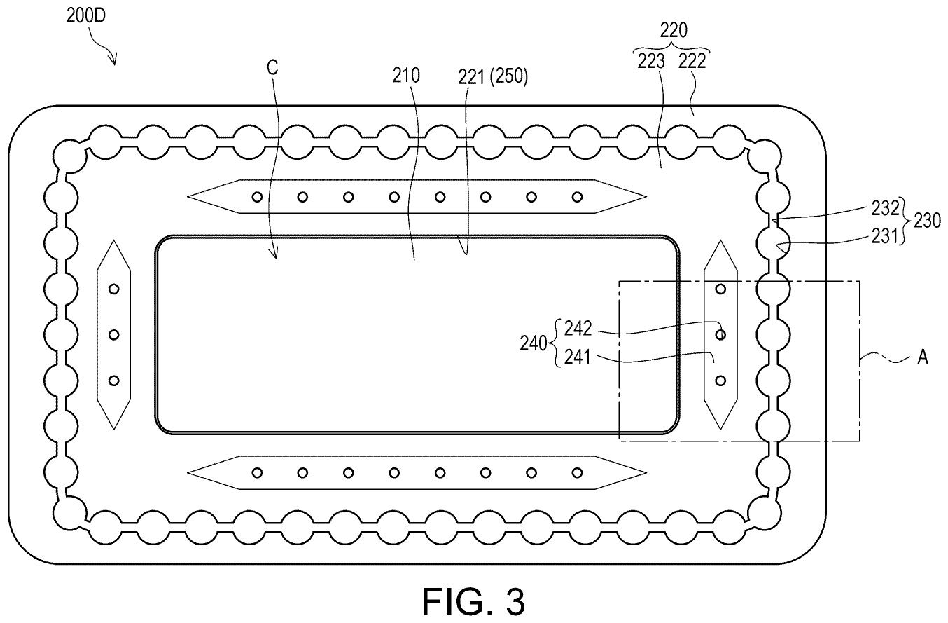

As shown in FIG. 2 and FIG. 3, the lower die 200D is arranged on an upper surface of the lower die base member 103. The upper surface (mold surface) of the lower die 200D is arranged to oppose the mold surface of the upper die 200U in the up-down direction. The lower die 200D mainly includes a main surface member 210 and a side surface member 220 and so on.

The main surface member 210 forms a main surface of the cavity C. In the present embodiment, since the main surface member 210 is the lower die 200D, the main surface is a bottom surface. The main surface member 210 is formed in a rectangular shape in plan view. The main surface member 210 is formed to have an appropriate width in the up-down direction. The main surface member 210 is arranged in a state of being placed on the upper surface of the lower die base member 103.

The side surface member 220 forms a side surface of the cavity C and surrounds the main surface member 210 from a side. The side surface member 220 is formed to have an appropriate width in the up-down direction. The side surface member 220 mainly includes a hollow part 221.

The hollow part 221 is formed to penetrate in the up-down direction through the center of the side surface member 220. The hollow part 221 is formed in a rectangular shape in plan view. In plan view, the hollow part 221 is formed in a shape that approximately matches an outer shape of the main surface member 210.

In this way, the side surface member 220 is formed in a frame-like shape that is rectangular in plan view. The main surface member 210 is arranged in the hollow part 221 of the side surface member 220. The side surface member 220 is placed on the upper surface of the lower die base member 103 via an elastic member 220a. The elastic member 220a is made of, for example, a compression coil spring that is able to expand and contract in the up-down direction. An upper surface of the side surface member 220 is located above the upper surface of the main surface member 210. A portion (above the main surface member 210 and inside the side surface member 220) surrounded by the main surface member 210 and the side surface member 220 configured in this way serves as the cavity C for performing resin molding.

The release film F is arranged on the mold surface of the lower die 200D configured in this way, and the resin material is supplied to the portion corresponding to the cavity C on the arranged release film F. Subsequently, since the release film F is adsorbed to the lower die 200D, the resin material is supplied into the cavity C. The pre-sealing substrate W1 is adsorbed and held by the upper die 200U. In this state, by the mold clamping mechanism 100, the upper die 200U and the lower die 200D can be clamped, and resin can be compression-molded on the pre-sealing substrate W1 to obtain the sealed substrate W2.

### Configuration of Lower Die 200D

Here, an adsorption hole for adsorbing and holding the release film F is appropriately formed in the lower die 200D. In the following, a structure of the lower die 200D for adsorbing the release film F will be specifically described.

As shown in FIG. 3 to FIG. 5, the lower die 200D includes a first adsorption part 230, a second adsorption part 240, and a third adsorption part 250 for adsorbing the release film F.

The first adsorption part 230 is for adsorbing the release film F to the upper surface of the side surface member 220. The first adsorption part 230 mainly includes a first suction hole 231, a second suction hole 232, and a suction channel 233.

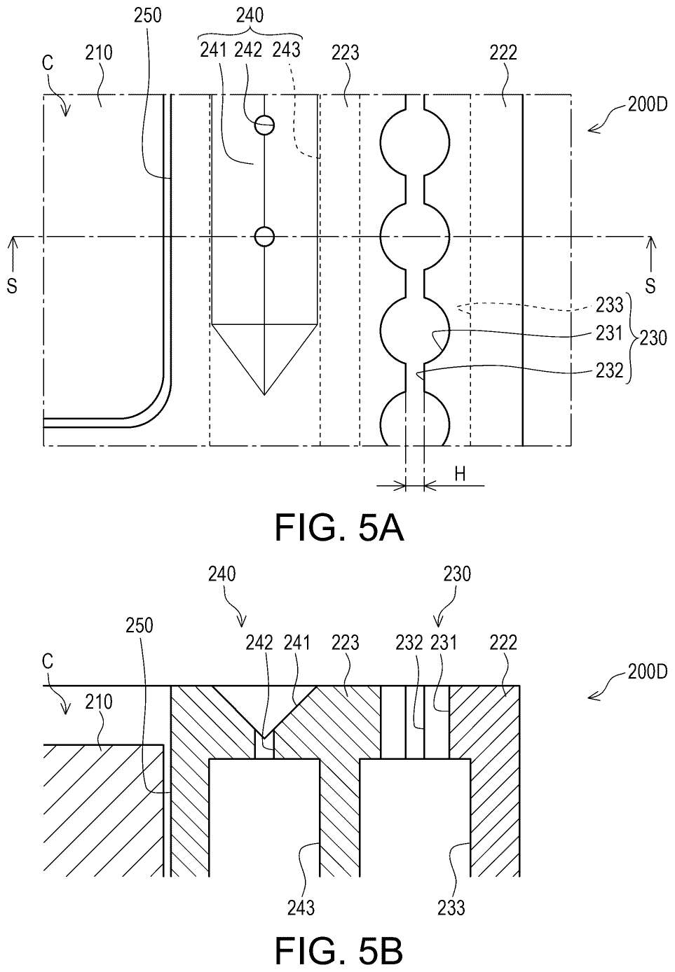

As shown in FIG. 3 and FIG. 5, the first suction hole 231 is a through-hole formed along the up-down direction to connect the upper surface of the side surface member 220 with the suction channel 233. The first suction hole 231 is formed in a circular shape in plan view. Multiple first suction holes 231 are formed side by side to surround a periphery of the cavity C in plan view. The first suction holes 231 are formed to be arranged in a rectangular shape following the shape of the cavity C in plan view. The first suction holes 231 are arranged side by side at approximately equal intervals. Adjacent first suction holes 231 are formed to be spaced apart by a distance of, for example, 0.05 mm or more. In the present embodiment, the first suction hole 231 is formed in a circular shape having a diameter of 1 to 5 mm in plan view.

The shape of the first suction hole 231 is not limited to circular shape, and may be any other shape having an area in plan view equivalent to the area (approximately 0.5 to 20 mm²) of a circle having a diameter of 1 to 5 mm. In the present embodiment, multiple first suction holes 231 are formed side by side so that the intervals between adjacent first suction holes 231 are approximately constant. However, it is also possible to form multiple first suction holes 231 at unequal intervals.

The second suction hole 232 is a through-hole formed along the up-down direction to connect the upper surface of the side surface member 220 with the suction channel 233. In plan view, the second suction hole 232 is formed to extend from one first suction hole 231 to another first suction hole 231 adjacent to the one first suction hole 231. In this way, the second suction hole 232 is formed to connect adjacent first suction holes 231. A width H (the width H which is a length in a direction perpendicular to a direction in which the second suction hole 232 extends to connect adjacent first suction holes 231) of the second suction hole 232 in plan view is formed to be approximately constant. The width H of the second suction hole 232 is formed to be, for example, 4 times or less the thickness of the release film F.

The width H of the second suction hole 232 is formed to be smaller than a width (a maximum length of the first suction hole 231 in the direction perpendicular to the direction in which the second suction hole 232 extends to connect adjacent first suction holes 231; in the present embodiment, the diameter of the first suction hole 231) of the first suction hole 231. Accordingly, the first suction hole 231 is formed to protrude to each of both sides in the width direction of the second suction hole 232 (for example, in a left-right direction of the paper of FIG. 5 (a)) with respect to the second suction hole 232. That is, the first suction hole 231 is formed to protrude to the inside (cavity C side) and the outside (side opposite to cavity C) of the lower die 200D with respect to the second suction hole 232.

The first suction hole 231 and the second suction hole 232 are formed to be connected in an alternate manner in plan view. The first suction hole 231 and the second suction hole 232 are formed to surround the periphery of the cavity C. In the present embodiment, the first suction hole 231 and the second suction hole 232 are formed to surround the cavity C without interruption. That is, the first suction hole 231 and the second suction hole 232 are formed in an endless ring shape in plan view, and the first suction hole 231 and the second suction hole 232 are continuously connected to surround the entire periphery of the cavity C. In this way, by the first suction hole 231 and the second suction hole 232 that open on the upper surface (mold surface) of the side surface member 220, an adsorption hole for adsorbing the release film F is formed. The first suction hole 231 and the second suction hole 232 are one embodiment of a release film adsorption hole of the disclosure.

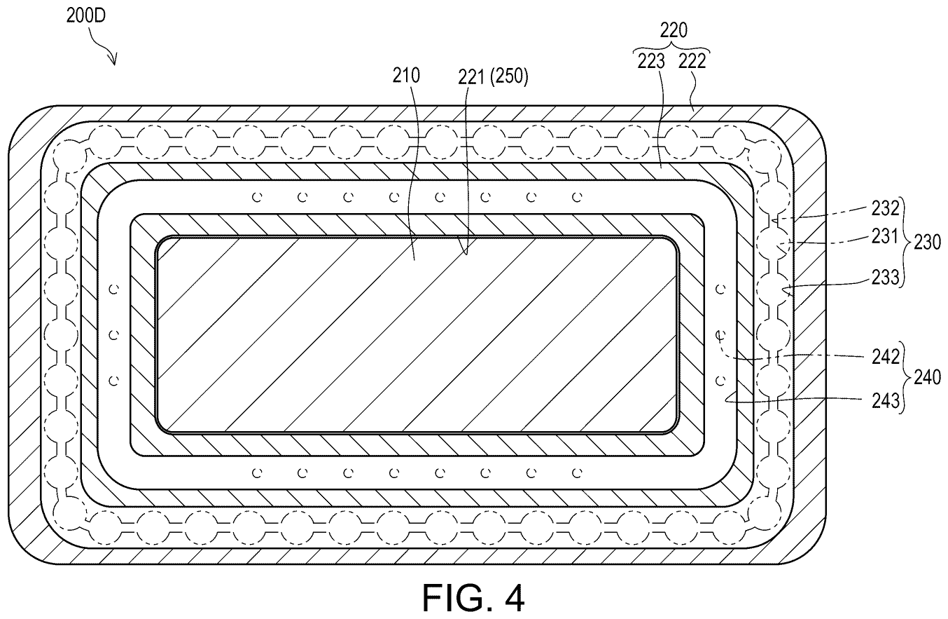

The suction channel 233 shown in FIG. 4 and FIG. 5 is for suctioning air from the first suction hole 231 and the second suction hole 232. The suction channel 233 is formed below the first suction hole 231 and the second suction hole 232. The suction channel 233 is formed to extend downward from an up-down direction intermediate portion of the side surface member 220. In plan view, the suction channel 233 is formed to extend along the first suction hole 231 and the second suction hole 232. That is, the suction channel 233 is also formed in an endless ring shape in plan view. An upper part of the suction channel 233 is connected to the first suction hole 231 and the second suction hole 232. A suction device (not shown) such as a vacuum pump is connected to a lower part of the suction channel 233 via an appropriately formed air circulation channel. By operating this suction device to suction air, air can be suctioned from the first suction hole 231 and the second suction hole 232 via the suction channel 233, and the release film F can be adsorbed to the upper surface of the side surface member 220.

As described above, the first suction hole 231, the second suction hole 232, and the suction channel 233 are formed to be continuously connected and surround the periphery of the cavity C without interruption. Hence, the side surface member 220 is separated into a portion outside the first suction hole 231 or the like and a portion inside the first suction hole 231 or the like, with the first suction hole 231 or the like in between in plan view. Hereinafter, the portion of the side surface member 220 that is outside the first suction hole 231 or the like is referred to as an outer member 222, and the portion inside the first suction hole 231 or the like is referred to as an inner member 223.

The second adsorption part 240 shown in FIG. 3 to FIG. 5 is for adsorbing the release film F to the upper surface of the side surface member 220 (inner member 223). The second adsorption part 240 mainly includes a concave part 241, a suction hole 242, and a suction channel 243.

The concave part 241 shown in FIG. 3 and FIG. 5 is a concave portion formed on an upper surface of the inner member 223. Multiple concave parts 241 are formed around the cavity C. In the present embodiment, four concave parts 241 are formed along each side of the cavity C formed in a rectangular shape in plan view. The concave part 241 is formed in a straight line shape parallel to each side of the cavity C. The four concave parts 241 are formed spaced at appropriate intervals so as not to be connected with each other. In a longitudinal cross-sectional view, the concave part 241 is formed in a V-shape that slopes downward toward the center.

The suction hole 242 is a through-hole formed along the up-down direction to connect the upper surface of the inner member 223 with the suction channel 243. The suction hole 242 is one embodiment of a third suction hole of the disclosure. The suction hole 242 is formed in a circular shape in plan view. In plan view, the suction hole 242 is formed inside the concave part 241. Multiple suction holes 242 are formed in each concave part 241.

The suction channel 243 shown in FIG. 4 and FIG. 5 is for suctioning air from the suction hole 242. The suction channel 243 is formed below the suction hole 242. The suction channel 243 is formed to extend downward from an up-down direction intermediate portion of the inner member 223. In plan view, the suction channel 243 is formed to extend along the concave part 241 and the suction hole 242. The suction channel 243 is formed in an endless ring shape to surround the cavity C in plan view. An upper part of the suction channel 243 is connected to the suction hole 242. A suction device (not shown) such as a vacuum pump is connected to a lower part of the suction channel 243 via an appropriately formed air circulation channel. By operating this suction device to suction air, air can be suctioned from the suction hole 242 via the suction channel 243, and the release film F can be adsorbed to the upper surface (concave part 241) of the inner member 223.

The third adsorption part 250 shown in FIG. 3 to FIG. 5 is for adsorbing the release film F to the cavity C. The third adsorption part 250 is formed by a gap between an outer surface of the main surface member 210 and an inner surface (hollow part 221) of the side surface member 220 (inner member 223). A gap is formed between the main surface member 210 and the side surface member 220 over the entire periphery of the main surface member 210 in plan view. Accordingly, the third adsorption part 250 is formed in an endless ring shape to surround the cavity C in plan view. A suction device (not shown) such as a vacuum pump is connected to a lower part of the third adsorption part 250 via an appropriately formed air circulation channel. By operating this suction device to suction air, air can be suctioned from the third adsorption part 250, and the release film F can be adsorbed along an inner surface of the cavity C.

The suction of air by the first adsorption part 230, the second adsorption part 240, and the third adsorption part 250 can be each independently performed. For example, by providing a valve in the air circulation channel connected to each of the first adsorption part 230, the second adsorption part 240, and the third adsorption part 250, and appropriately controlling the opening and closing of each valve, each of the first adsorption part 230, the second adsorption part 240, and the third adsorption part 250 can be made to suction at any arbitrary timing.

In the present embodiment, for the purpose of description, dimensions (such as sizes or positions) of the first adsorption part 230, the second adsorption part 240, and the third adsorption part 250 are illustrated in an exaggerated manner as appropriate. The actual dimensions of the first adsorption part 230 or the like are not limited to those shown in the figures.

### Adsorption of Release Film F

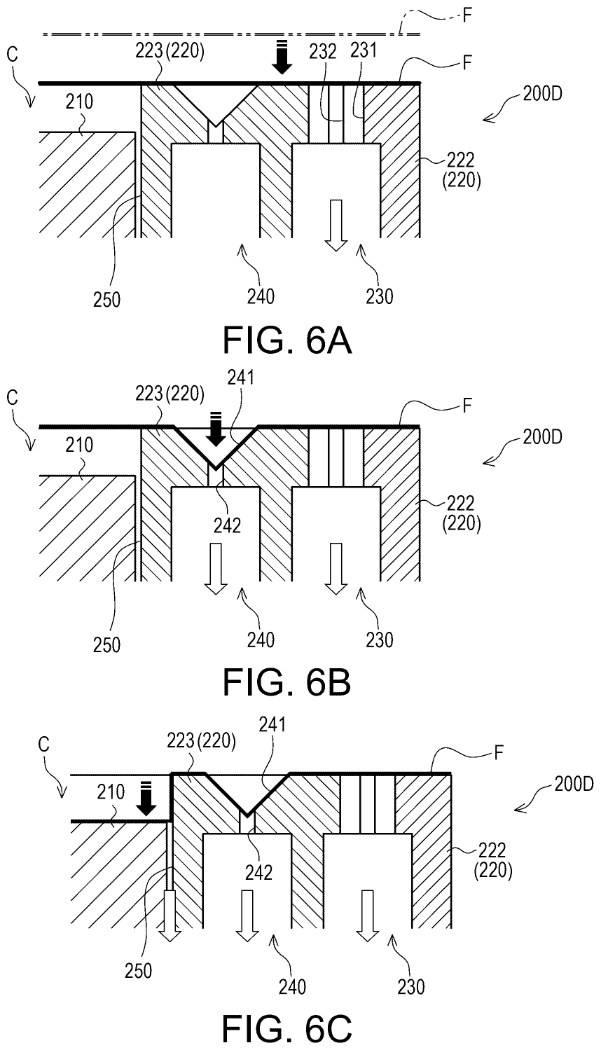

The following describes, using FIG. 6, a state in which the release film F is adsorbed to the lower die 200D configured as described above during the film arrangement process. In the present embodiment, as described above, the resin material is actually placed on top of the release film F. However, the resin material is omitted from the following figures and description.

First, as shown in FIG. 6 (a), when the release film F is arranged on the lower die 200D, air suction by the first adsorption part 230 is performed. Accordingly, air is suctioned via the first suction hole 231 and the second suction hole 232, and the release film F is adsorbed to the upper surface of the side surface member 220.

Here, as shown in FIG. 5 (a), since the first adsorption part 230 has the first suction hole 231 having a relatively large area, the first adsorption part 230 is able to hold the release film F with a relatively large adsorption force. Furthermore, since the second suction hole 232 connects between adjacent first suction holes 231, the release film F can be adsorbed even between adjacent first suction holes 231. In particular, in the present embodiment, the first suction hole 231 and the second suction hole 232 are formed to be continuously connected and surround the cavity C without interruption. By the first suction hole 231 and the second suction hole 232 that are continuous in this way, the adsorption force can be exerted without gaps, thereby allowing the release film F to be firmly held. Accordingly, even if the release film F is about to deform away from the mold surface of the lower die 200D due to the heat of the lower die 200D, the release film F can continue to be held, and air can be prevented from leaking from the first adsorption part 230.

Furthermore, by connecting the first suction holes 231 that are relatively large with the second suction hole 232 that is small in width, it can be prevented that the release film F is drawn into the first suction hole 231 by the adsorption force of the first adsorption part 230. Accordingly, adsorption defects (such as the occurrence of wrinkles or slipping) of the release film F can be prevented.

Next, as shown in FIG. 6 (b), in the state in which air suction by the first adsorption part 230 is performed, air suction by the second adsorption part 240 is performed. Accordingly, air is suctioned via the suction hole 242, and the release film F is adsorbed to the concave part 241. By drawing the release film F into the concave part 241 in this way, the release film F can be stretched, and tension can be imparted to the release film F.

Next, as shown in FIG. 6 (c), in the state in which air suction by the first adsorption part 230 and the second adsorption part 240 is performed, air suction by the third adsorption part 250 is performed. Accordingly, the release film F is adsorbed to follow the inner surface of the cavity C. By drawing the release film F in this way, the release film F can be further stretched, and tension can be imparted to the release film F. At this time, the resin material (not shown) is actually supplied into the cavity C along with the release film F.

In this way, in the present embodiment, after the release film F is adsorbed by the first adsorption part 230, the adsorption by the second adsorption part 240 and the third adsorption part 250 is performed, thereby imparting tension to the release film F. At this time, since the release film F is firmly held by the first adsorption part 230 as described above, adsorption defects (such as the occurrence of wrinkles or slipping) of the release film F caused by the adsorption by the second adsorption part 240 and the third adsorption part 250 can be prevented. Accordingly, molding defects or release defects can be prevented from occurring in the resin molded product.

The first embodiment of the disclosure has been described above. However, the disclosure is not limited to the above embodiment, and appropriate modifications are possible within the scope of the technical idea of the invention described in the claims.

For example, the configuration (such as shape, arrangement, and number) of each part of the resin molding apparatus 1 described in the present embodiment is not particularly limited and may be arbitrarily modified.

In the present embodiment, the upper die 200U adsorbs and holds a substrate (such as the pre-sealing substrate W1). However, the disclosure is not limited thereto. For example, a configuration is also possible in which the substrate is held by the lower die 200D.

In the present embodiment, an example is shown in which the first suction hole 231 is formed in a circular shape in plan view (see FIG. 5 (a)). However, the disclosure is not limited thereto. It is also possible to form the first suction hole 231 in any arbitrary shape. For example, the first suction hole 231 can be formed in a polygonal shape such as a triangular shape or a rectangular shape in plan view, an elliptical shape, or any other arbitrary shape.

In the present embodiment, an example is shown in which the second suction hole 232 is formed in a groove shape (slit shape) having a constant width H (see FIG. 5 (a)). However, the disclosure is not limited thereto. It is also possible to form the second suction hole 232 in any arbitrary shape. For example, the second suction hole 232 can be formed in a circular shape in plan view, a polygonal shape, or any other arbitrary shape. In this case, it is desirable to set the width H (minimum width or maximum width) of the second suction hole 232 to be small enough not to draw in the release film F.

The dimensions (such as the area and diameter of the first suction hole 231, and the width H of the second suction hole 232) of the first suction hole 231 and the second suction hole 232 shown in the present embodiment are examples and may be arbitrarily modified.

In the present embodiment, an example is shown in which the first suction hole 231 and the second suction hole 232 are formed to be arranged in a rectangular shape following the shape of the cavity C in plan view. However, the disclosure is not limited thereto. It is possible that the first suction hole 231 and the second suction hole 232 are formed and arranged in any arbitrary shape.

In the present embodiment, an example is shown in which multiple first suction holes 231 are arranged side by side at approximately equal intervals. However, the disclosure is not limited thereto. For example, it is possible that first suction holes 231 are arranged side by side at any arbitrary intervals, such as at unequal intervals.

In the present embodiment, the molding die 200 of a rectangular shape in plan view is described as an example. However, the shape of the molding die 200 is not limited thereto. For example, it is possible to use a molding die 200 of any arbitrary shape, such as a circular shape in plan view.

The shape of the release film F used in the present embodiment is not particularly limited. For example, it is possible to use a release film F of a rectangular shape or circular shape as the release film F. The shape of the release film F can also be appropriately selected according to the shape of the molding die 200 or the like.

The material of the release film F used in the present embodiment is not particularly limited. For example, it is possible to use a resin film, metal foil, rubber sheet, or a composite thereof as the release film F.

In the present embodiment, the molding die 200 (lower die 200D) including the second adsorption part 240 (see FIG. 5) is illustrated as an example. However, the disclosure is not limited thereto. It is also possible to apply the disclosure to a molding die 200 that does not include the second adsorption part 240.

In the present embodiment, an example is described in which the resin material is conveyed to the lower die 200D along with the release film F. However, the disclosure is not limited thereto. It is possible that the release film F and the resin material are separately conveyed to the lower die 200D.

In the present embodiment, an example is described in which the release film F is adsorbed and held in the lower die 200D. However, the disclosure is not limited thereto. It is possible that the release film F is adsorbed and held in the upper die 200U.

### 21 Second Embodiment

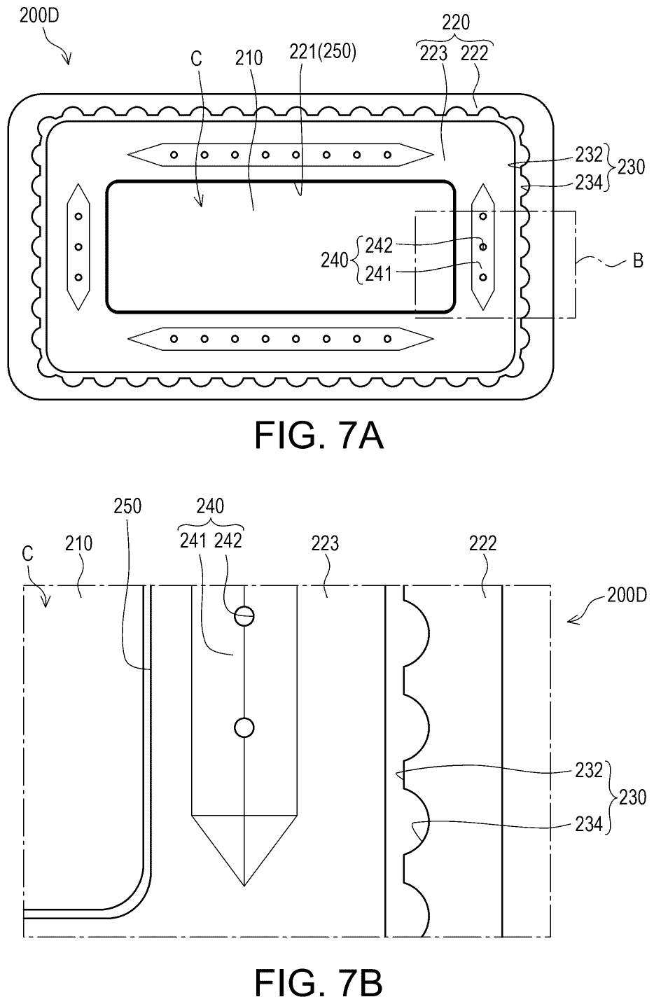

The following describes the lower die 200D according to a second embodiment using FIG. 7.

The lower die 200D according to the second embodiment differs from the first embodiment in that the lower die 200D according to the second embodiment has a first suction hole 234 of a shape different from the first suction hole 231 of the lower die 200D (see FIG. 3 and FIG. 5) according to the first embodiment. Thus, the following mainly describes this difference. With respect to other configurations that are identical to the first embodiment, the same reference numerals are assigned and their descriptions are omitted.

The first suction hole 234 is formed in a semicircular shape in plan view. The first suction hole 234 is formed to protrude only to the outside (side opposite to the cavity C) of the lower die 200D with respect to the second suction hole 232. That is, the first suction hole 234 is formed on an inner surface of the outer member 222.

In this way, unlike the first embodiment, it is possible to form the first suction hole 234 in a semicircular shape. Even in this case, the release film F can be firmly held while being prevented from being drawn into the first suction hole 234.

By forming the first suction hole 234 to protrude only to the outside as in the second embodiment, space can be secured on the inside (cavity C side) of the second suction hole 232. For example, the entire first adsorption part 230 can be formed closer to the inside of the lower die 200D. Accordingly, the lower die 200D can be reduced in size.

By forming the first suction hole 234 only in the outer member 222 as in the second embodiment, a machining process at the time of forming the first suction hole 234 can be simplified. Accordingly, the manufacturing cost of the lower die 200D can be reduced.

In the second embodiment, an example is shown in which the first suction hole 234 is formed to protrude only to the outside with respect to the second suction hole 232. However, the disclosure is not limited thereto. For example, it is also possible to form the first suction hole 234 to protrude only to the inside with respect to the second suction hole 232. It is also possible to combine the first suction hole 234 that protrudes only to the outside with respect to the second suction hole 232 with the first suction hole 234 that protrudes only to the inside with respect to the second suction hole 232.

### Third Embodiment

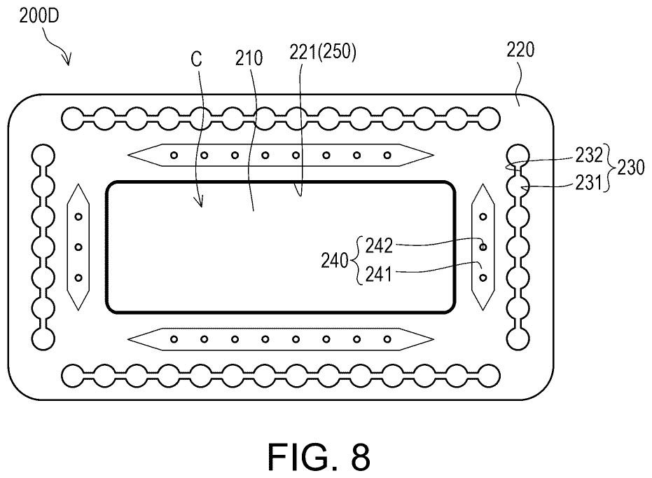

The following describes the lower die 200D according to a third embodiment using FIG. 8.

The lower die 200D according to the third embodiment differs from the first embodiment in that a portion of the first suction hole 231 and the second suction hole 232 formed to surround the cavity C is interrupted. Specifically, in the third embodiment, the first suction hole 231 and the second suction hole 232 are formed to be interrupted near four corners of the lower die 200D.

In this way, by forming the first suction hole 231 and the second suction hole 232 to be partially interrupted, when the release film F is adsorbed by the second adsorption part 240 or the third adsorption part 250, it can be prevented that excessive tension is applied to the release film F and wrinkles or slipping occur in the release film F.

In the case of forming the first suction hole 231 and the second suction hole 232 to be partially interrupted in this way, it is possible to form the side surface member 220 as a single integrated member instead of dividing the side surface member 220 into two members (outer member 222 and inner member 223) as in the first embodiment.

It is possible that the first suction hole 231 and the second suction hole 232 are interrupted at any arbitrary portion. This interrupted portion can be arbitrarily determined according to, for example, the shape of each part of the lower die 200D or the adsorption force of each suction part.

### Supplementary Note

A molding die 200 of a first aspect of the disclosure is as follows. The molding die 200 includes an upper die 200U (one die) and a lower die 200D (the other die) arranged opposing the upper die 200U and having a cavity C where a release film F is arranged. The lower die 200D includes a main surface member 210 forming a main surface of the cavity C, and a side surface member 220 forming a side surface of the cavity C. On an opposing surface of the side surface member 220 that opposes the upper die 200U, a release film adsorption hole (first suction hole 231 and second suction hole 232) that adsorbs the release film F is formed including multiple first suction holes 231 and a second suction hole 232 connecting adjacent ones of the first suction holes 231. On the opposing surface, the first suction hole 231 is larger than the second suction hole 232 in terms of a length in a direction perpendicular to a direction in which the second suction hole 232 extends to connect adjacent ones of the first suction holes 231.

According to the molding die 200 of the first aspect of the disclosure, molding defects or release defects can be prevented from occurring in a resin molded product. That is, by connecting the first suction holes 231 that are relatively large with the second suction hole 232 that is relatively small in width, while the release film F is adsorbed with a relatively large adsorption force, it can be prevented that the release film F is drawn into the first suction hole 231. Accordingly, adsorption defects (such as the occurrence of wrinkles or slipping) of the release film F can be prevented, and the occurrence of molding defects or release defects in the resin molded product due to the adsorption defects of the release film F can be prevented.

In the molding die 200 of a second aspect according to the first aspect, the first suction hole 231 is formed to protrude to at least one of the cavity C side and a side opposite to the cavity C with respect to the second suction hole 232.

According to the molding die 200 of the second aspect of the disclosure, the first suction hole 231 can be formed in a relatively simple manner.

In the molding die 200 of a third aspect according to the first or second aspect, the release film adsorption hole (first suction hole 231 and second suction hole 232) is formed to be continuously connected and surround a periphery of the cavity C.

According to the molding die 200 of the third aspect of the disclosure, the release film F can be firmly held over the entire periphery of the cavity C. Accordingly, adsorption defects of the release film F can be relatively effectively prevented.

In the molding die 200 of a fourth aspect according to the third aspect, the side surface member 220 includes: an inner member 223 constituting a portion closer to the cavity C side than the release film adsorption hole; and an outer member 222 composed of a different member from the inner member 223 and constituting a portion closer to the side opposite to the cavity C than the release film adsorption hole.

According to the molding die 200 of the fourth aspect of the disclosure, by separating the side surface member 220 into the inner member 223 and the outer member 222, the release film adsorption hole (first suction hole 231 and second suction hole 232) can be easily machined.

In the molding die 200 of a fifth aspect according to the fourth aspect, the first suction hole 231 is formed in the outer member 222.

According to the molding die 200 of the fifth aspect of the disclosure, by forming the first suction hole 231 in the outer member 222, the inner member 223 can be reduced in size, and consequently, the molding die 200 can be reduced in size.

In the molding die 200 of a sixth aspect according to the first to fifth aspects, on the opposing surface of the side surface member 220, on the cavity C side of the release film adsorption hole, a concave part 241 and a suction hole 242 (third suction hole) capable of suctioning air inside the concave part 241 are formed.

According to the molding die 200 of the sixth aspect of the disclosure, by drawing the release film F into the concave part 241, tension can be applied to the release film F. Accordingly, adsorption defects of the release film F can be relatively effectively prevented.

The resin molding apparatus 1 of a seventh aspect of the disclosure includes the molding die 200 of any of the first to sixth aspects.

According to the resin molding apparatus 1 of the seventh aspect of the disclosure, molding defects or release defects can be prevented from occurring in the resin molded product.

A method for producing a resin molded product of an eighth aspect of the disclosure is a method for producing a resin molded product using the resin molding apparatus 1 of the seventh aspect. The method includes: a film arrangement process for arranging the release film F on the lower die 200D; and a resin molding process for performing resin molding using the lower die 200D on which the release film F is arranged.

According to the method for producing a resin molded product of the eighth aspect of the disclosure, molding defects or release defects can be prevented from occurring in the resin molded product.

### DESCRIPTION OF REFERENCE NUMERALS

1: resin molding apparatus
200: molding die
200D: lower die
200U: upper die
210: main surface member
220: side surface member
222: outer member
223: inner member
230: first adsorption part
231: first suction hole
232: second suction hole
240: second adsorption part
241: concave part
242: suction hole

1. A molding die, comprising one die and an other die arranged opposing the one die, the other die having a cavity where a release film is arranged, wherein
the other die comprises a main surface member forming a main surface of the cavity and a side surface member forming a side surface of the cavity;
on an opposing surface of the side surface member that opposes the one die, a release film adsorption hole that adsorbs the release film is formed comprising a plurality of first suction holes and a second suction hole connecting adjacent ones of the first suction holes;
on the opposing surface, the first suction hole is larger than the second suction hole in terms of a length in a direction perpendicular to a direction in which the second suction hole extends to connect adjacent ones of the first suction holes.

2. The molding die according to claim 1, wherein
the first suction hole is formed to protrude to at least one of the cavity side and a side opposite to the cavity with respect to the second suction hole.

3. The molding die according to claim 1, wherein
the release film adsorption hole is formed to be continuously connected and surround a periphery of the cavity.

4. The molding die according to claim 3, wherein
the side surface member comprises:
an inner member constituting a portion closer to the cavity side than the release film adsorption hole; and
an outer member composed of a different member from the inner member, and constituting a portion closer to a side opposite to the cavity than the release film adsorption hole.

5. The molding die according to claim 4, wherein
the first suction hole is formed in the outer member.

6. The molding die according to claim 1, wherein
on the opposing surface of the side surface member, on the cavity side of the release film adsorption hole, a concave part and a third suction hole capable of suctioning air inside the concave part are formed.

7. A resin molding apparatus, comprising the molding die according to claim 1.

8. A method for producing a resin molded product using the resin molding apparatus according to claim 7, comprising:
arranging the release film on the other die; and
performing resin molding using the other die on which the release film is arranged.
